(19) United States
(12) Patent Application Publication
(10) Pub. No.: US 2011/0089741 A1
(43) Pub. Date: Apr. 21, 2011

(54) Self inflating bellows chair

(76) Inventor: Randolph Lee Cyr, Venice, CA (US)

(21) Appl. No.: 12/925,002

(22) Filed: Oct. 12, 2010

Related U.S. Application Data
(60) Provisional application No. 61/251,833, filed on Oct. 15, 2009.

(51) Int. Cl. A47C 4/54

(52) U.S. Cl. 297/452.41

(57) ABSTRACT

A self inflating bellows chair with a hollow bodied chair shape and an attached an air valve. The chair shape is molded from firm yet resilient plastic that has the ability to perform a compressible and expandable bellows function. The hollow bodied chair shape has expandable and compressible accordion type side and arm panels. The air valve is fixedly attached to the side wall of the chair. The air valve has a spring biased relief vent where air is allowed to escape when a valve cover plate is pushed by a user. A preferred embodiment includes the chair automatically expands when released from its flattened condition.

### CROSS REFERENCE TO RELATED APPLICATIONS

This application is based on provisional application Ser. No. 61/251,833, filed on Oct. 15, 2009.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of chair type furniture and more specifically to a self inflating bellows chair.

Chairs of all sizes and shapes and made of a wide variety of materials have been in existence since civilization began to allow people to sit for a variety of purposes such as relaxing, eating, office work and the like.

Some chairs meant for relaxation purposes have been designed to collapse in one way or another for compact storage purposes. Other chairs have been designed to be adjustable to be able to be made more firm or more soft.

One such chair is the inflatable chair that is generally made from flexible vinyl. When it is blown up it can support a person's weight. The inflatable chair can also be inflated or deflated to varying degrees to make the chair firmer or softer to sit on. Obviously, the deflated chair can compress to a small size which allows it to be easily stored or shipped.

However, there is are deficiencies in the prior technology of inflatable chairs. The first being that over time, inflatable chairs made of flexible vinyl can deflate thereby causing the user to continually add air to the chair. Secondly, current inflatable chairs tend to feel unsteady when sat on because of the natural spring compression of the air inside the chair coupled with the extremely flexible nature of the sheet plastic that is used in production of such chairs. Thirdly, current inflatable chairs are not self inflating. Finally, inflatable chairs are vulnerable to puncture damage because of the relatively thin wall thickness of the plastic used in such chairs.

### BRIEF SUMMARY OF THE INVENTION

The primary object of the invention is to provide a chair that can be expanded to full size or compressed to a flat compact size.

Another object of the invention is to provide a chair that automatically expands to full size when an air valve is opened.

Another object of the invention is to provide a chair that is inexpensive to manufacture in comparison to other standard chairs of similar size and shape.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a self inflating bellows chair comprising: a hollow bodied chair shape, an air valve, said chair shape molded from firm yet resilient plastic that has the ability to perform a compressible and expandable bellows function, said hollow bodied chair shape having expandable and compressible accordion type front, rear, side and arm panels, said air valve fixedly attached to the rear wall of said chair, and said air valve having a spring biased relief vent where air is allowed to escape when a valve cover plate is pushed by a user.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention in the raised position.

FIG. 2 is a perspective view of the invention in the lowered position.

FIG. 3 is a top plan view of the invention,

FIG. 4 is a side section view of the invention.

FIG. 5 is a side section view of the valve of the invention.

FIG. 6 is a side view of the invention in the raised position.

FIG. 7 is a side view of the invention in the lowered position.

FIG. 8 is a front view of the invention in the lowered position.

FIG. 9 is a front view of the invention in the raised position.

FIG. 10 is a rear view of the invention in the raised position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

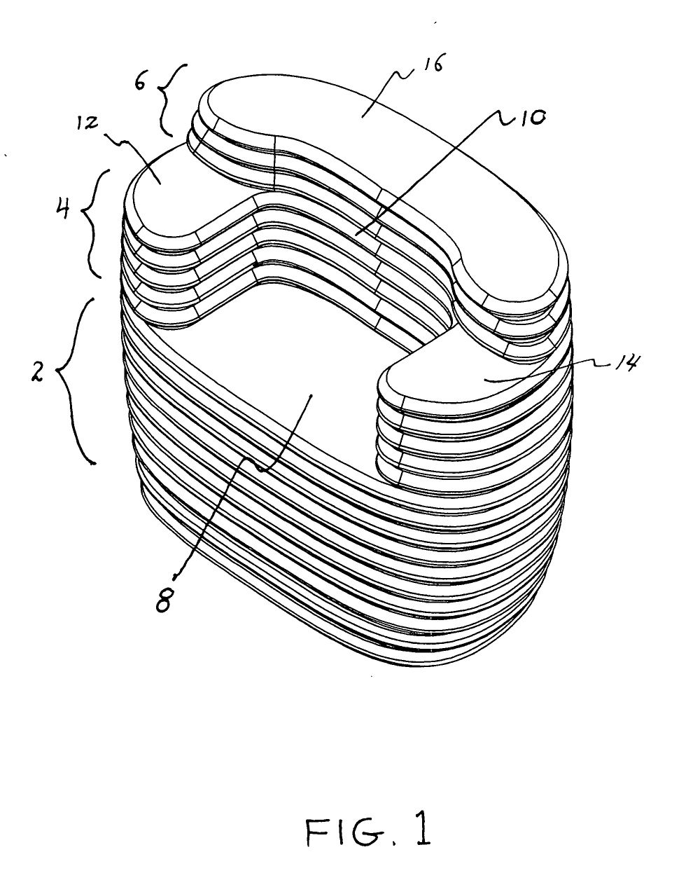

Referring now to FIG. 1 we see a perspective view of the bellows chair or the present invention in the raised position. This chair is made of blow molded plastic, preferably polyethylene or polypropylene, both of which have the properties of firmness yet enough resiliency to allow the chair to be compressed in a similar way that a bellows or accordion is compressed. The entire assembly is hollow and forms an air tight envelope. A similar bellows technology can be found in some collapsible drink bottles such as the Aquatina Water Bottle, made by Aquatina Ltd, London, England. Horizontal surface 8 forms the seat of the chair and which is supported by lower side walls 2. Left and right vertical columns 12, 14 form arm rests. The arm rest sides 4 continue in an unbroken fashion to form the back rest 10. A raised portion 6 forms the upper portion of the back rest. A top ledge 10 leads to the back wall 36 shown in subsequent Figures.

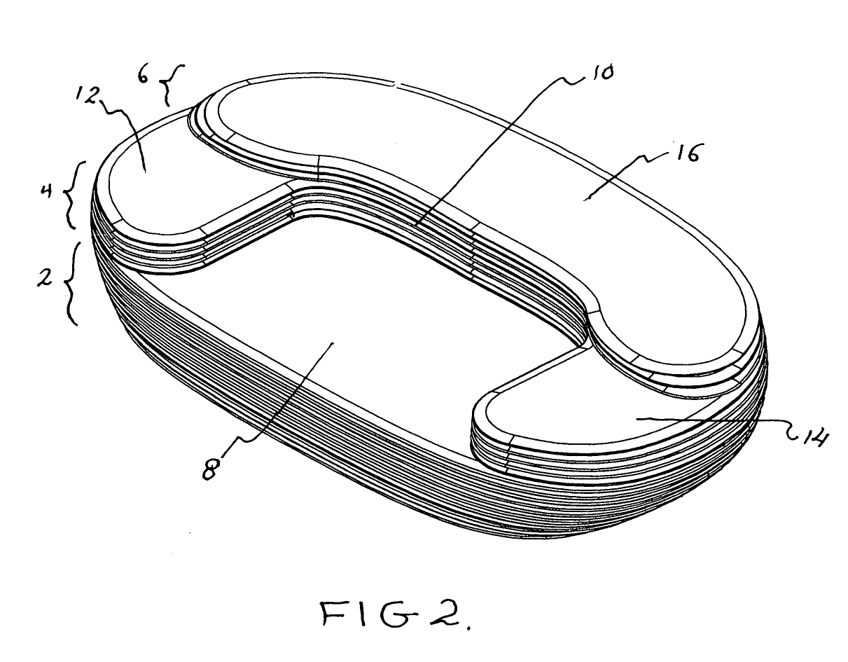

FIG. 2 shows the bellows chair of the present invention in the lowered position. The accordion pleats that form the front, sides and rear of the chair have been compressed so that the entire chair takes up a fraction of the space compared to its raised state. This collapsed mode allows for compact storage and transport.

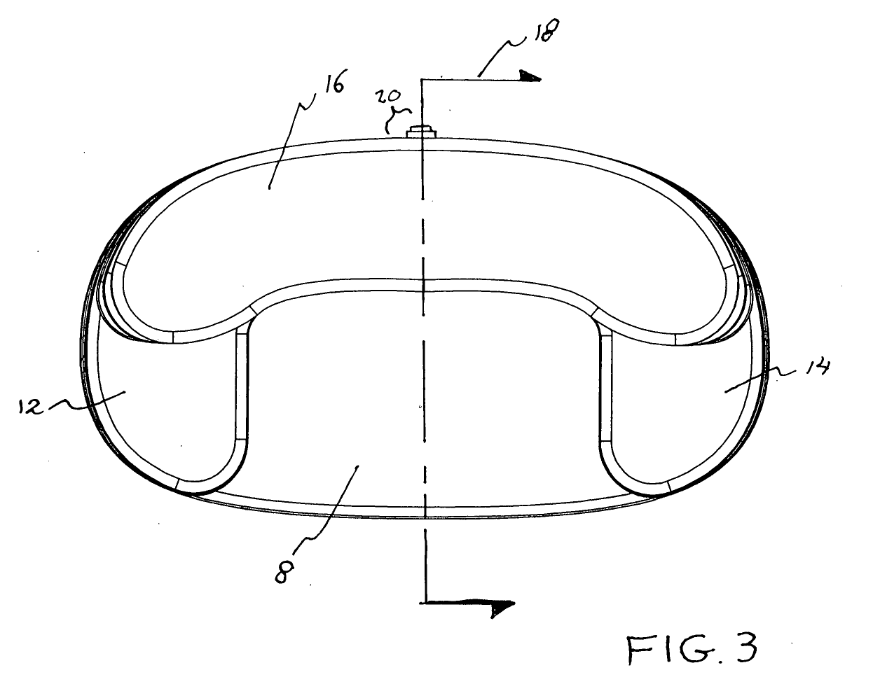

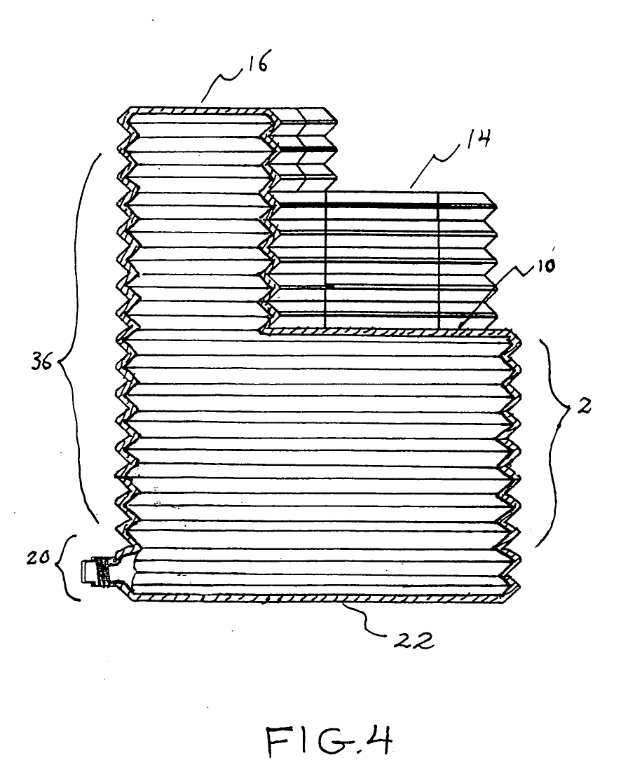

FIG. 3 is a top plan view of the bellows chair of the present invention. Section line 18 vertically bisects the chair. The bisected section view 18 is shown in FIG. 4. This view shows that the chair structure is hollow. The accordion pleats can be seen in section view as part of the base 2 and rear wall 36. The pleats extend around the entire perimeter of the chair in a bellows or accordion fashion. At the lower portion of the rear of the chair a valve 20 can be seen.

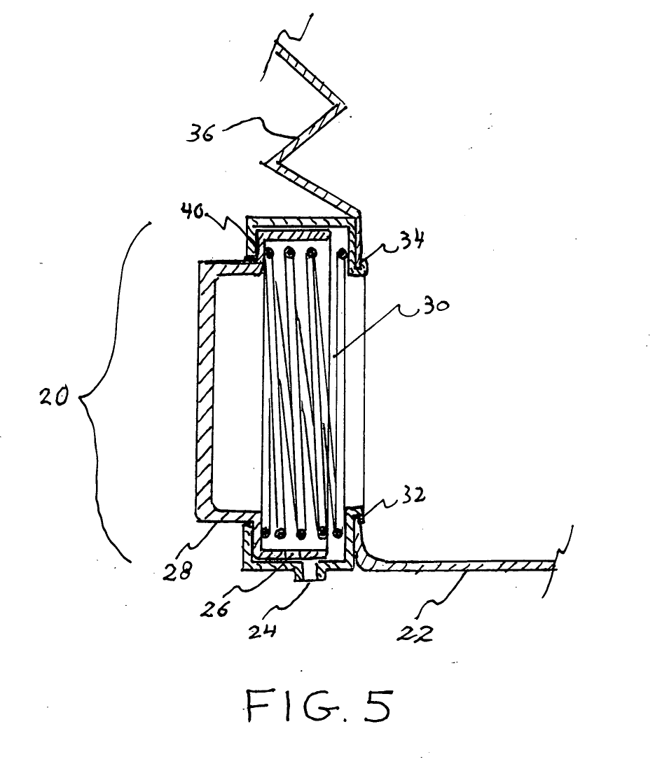

The valve 20 can be seen in detail in the enlarged section view shown in FIG. 5. The valve 20 is welded to the chair body at surface 32, 34. A spring biased valve cover 28 is held in place by compression spring 30 so that the outer ledge of the valve cover mates in an air tight manner with the inner return wall of the valve body 26. When a user presses on the outside of valve body cover 28, the downward movement aligns an aperture 26 in the side wall of the valve cover with an aperture 24 in the side wall of the valve body thereby allowing air to escape from the inside hollow portion of the chair. Because of the firm nature of the plastic used in the manufacture of the chair, the chair will only collapse if a person puts weight in the top or bottom surface of the chair. One way of collapsing the chair is to have a person sit on the top or bottom surface of the chair while holding the valve cover 28 down thereby allowing air to escape. When the chair has reached the collapsed position as shown in FIGS. 2, 7 and 8, The user can release the valve cover 28 thereby closing off the air pathway and causing a small vacuum to be formed within the hollow space of the chair. The vacuum prevents that chair from popping up again until the user presses on valve cover 28 at which time the chair self inflates due to the inherent springy nature of the molded plastic accordion pleats that form the side walls of the chair.

An air pump may be added to valve assembly 20 so that the user may add additional air as necessary to increase the firmness of the chair. Removal of air decreases firmness, but because of the general firm quality of the plastic used in the chair, the general chair shape and feeling of stability will be maintained even when air is released from the hollow space of the chair.

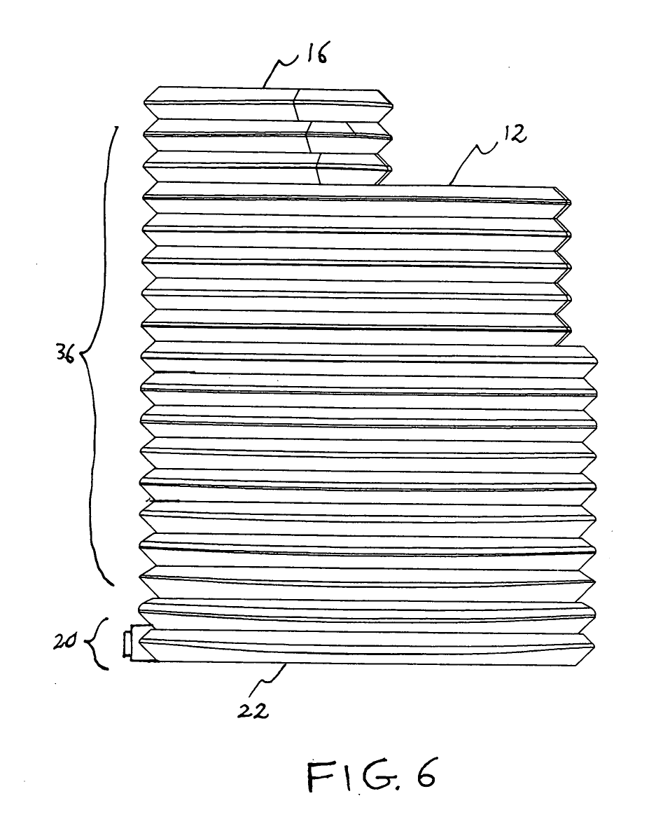

FIG. 6 shows a side view of the chair in the raised positron so that the accordion pleats 36 of the side, front and rear walls are expanded.

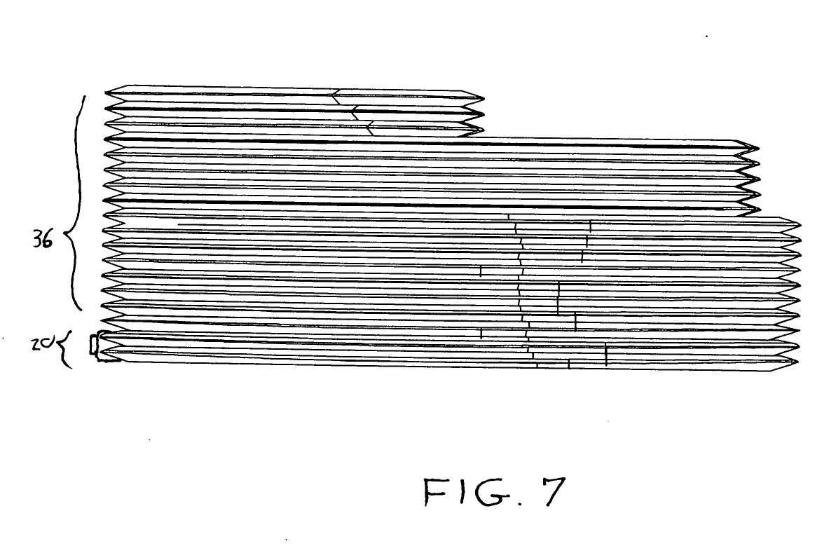

FIG. 7 shows the same side walls in their compressed position where the pleats 36 are flattened on top of each other.

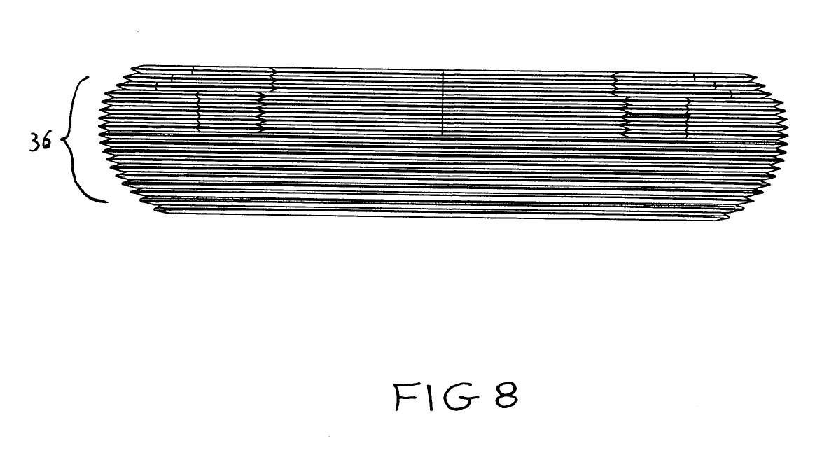

FIG. 8 shows a front view of the chair in the compressed, lowered position.

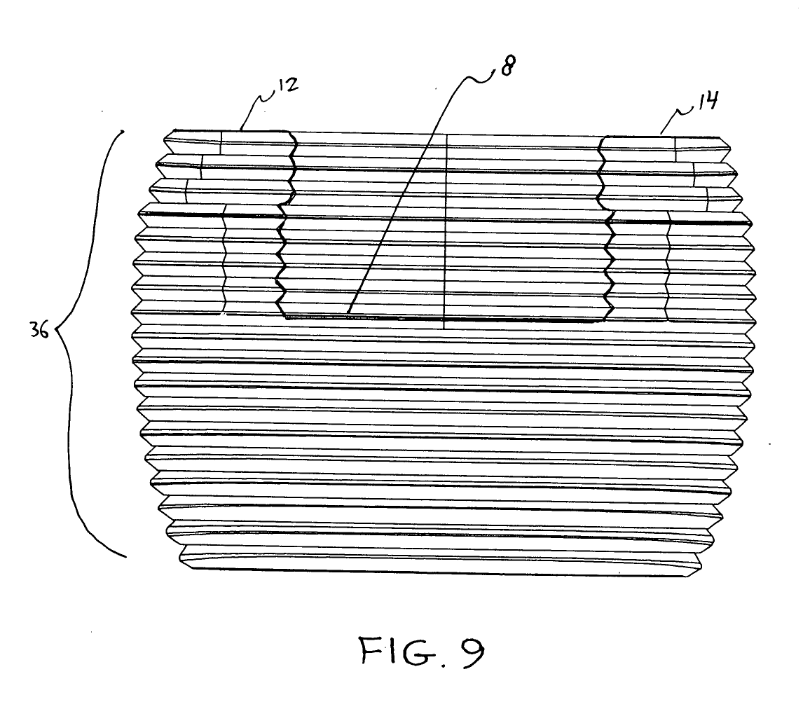

FIG. 9 shows a front view of the chair in the raised position

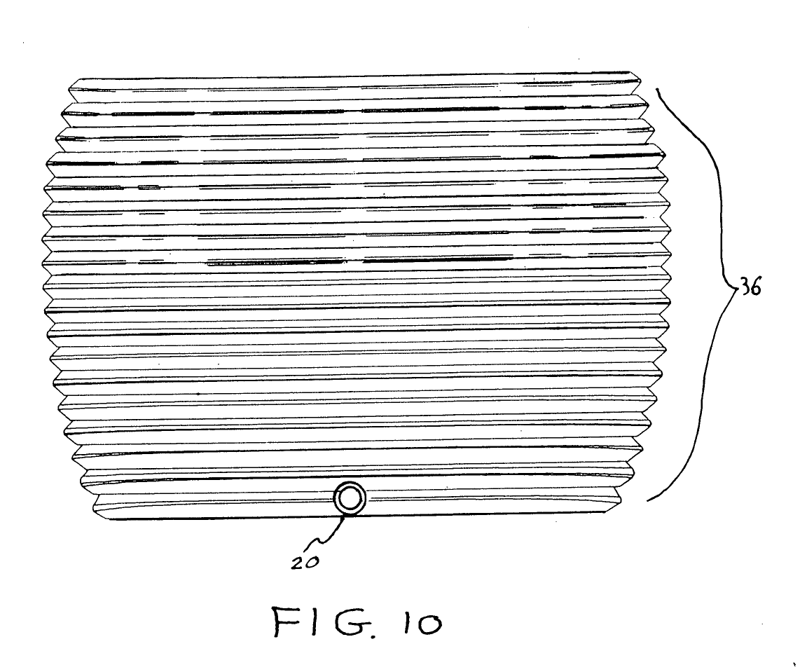

FIG. 10 shows a rear view of the chair in the raised position, with valve 20 being shown head on.

It should be obvious that other shaped chairs can be made in this way, such as sofas or a narrower single seat chair or love seat. Additionally, other types of collapsible furniture can be envisioned including but not limited to children's furniture, floor lamps, tables, desks coolers, sports seats and portable lamps.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. self inflating bellows chair comprising:
a hollow bodied chair shape;
an air valve;
said chair shape molded from firm yet resilient plastic that has the ability to perform a compressible and expandable bellows function;
said hollow bodied chair shape having expandable and compressible accordion type side and arm panels;
said air valve fixedly attached to a side wall of said chair; and
said air valve having a spring biased relief vent where air is allowed to escape when a valve cover plate is pushed by a user.

2. A self inflating bellows chair as claimed in claim 1 wherein said chair automatically rises when released from its flattened condition by opening said valve.

3. A self inflating bellows chair as claimed in claim 1 wherein said chair can be deflated by means of a person sitting on said chair while pressing on said spring biased air valve cover plate.

4. A self inflating bellows chair as claimed in claim 1 wherein said valve cover plate, once released by said user, causes said chair to remain in said raised or lowered position.

5. A self inflating bellows chair as claimed in claim 1 wherein said chair body is blow molded from polypropylene.

6. A self inflating bellows chair as claimed in claim 1 wherein said chair body is blow molded from high density polyethylene.

7. A self inflating bellows chair as claimed in claim 1 further comprising an air pump connected to said air valve allows for forced injection or removal of air into or out of said hollow chair body.
